(19) United States
(12) Patent Application Publication
(10) Pub. No.: US 2008/0022845 A1
(43) Pub. Date: Jan. 31, 2008

(54) PORTABLE ELECTRONIC DEVICE WITH A SONG SELCETION FUNCTION

(75) Inventors: Shin-Hong Chung, Shenzhen City (CN); Zai-An Pan, Shenzhen City (CN)

Correspondence Address: NORTH AMERICA INTELLECTUAL PROPERTY CORPORATION, P.O. BOX 506, MERRIFIELD, VA, 22116, US

(73) Assignees: ENSKY TECHNOLOGY (SHENZHEN) CO., LTD., Shenzhen City (CN); ENSKY TECHNOLOGY CO., LTD., Taipei Hsien (TW)

(21) Appl. No.: 11/828,350

(22) Filed: Jul. 26, 2007

(30) Foreign Application Priority Data
Jul. 26, 2006 (CN) 200610200747.7

(51) Int. Cl. G10H 7/00

(52) U.S. Cl. 84/609

(57) ABSTRACT

A portable electronic device with a song selection function is disclosed. The device includes a storage unit, a processing unit, a display unit, an input unit and a wireless communication unit. The processing unit further includes a list displaying module and a song selecting module. A user can make use of the device to browse or select songs rapidly to play at a multimedia system in an efficient method, without the need for the user to remember the song titles or artist(s) name of the song in advance of making a selection. Consequently, the device avoids searching for songs from a complex multimedia system and is convenient for the user to select desired songs. The present invention also provides a method for achieving a song selection function.

### BACKGROUND of the Invention

1. Field of the Invention

The present invention relates to a portable electronic device, and in particular, to a portable electronic device with a song selection function.

2. General Background

Portable electronic devices are ubiquitous and underutilized, such as mobile phone, multimedia player. Many mobile phones have a lot of functions themselves, such as messages, phonebook, and fun box. Many multimedia players store a plurality of songs and are only used for listening the songs. Thus portable electronic devices are prime targets for being used as a substitute for other devices. One possible use is as a remote control device.

Multimedia systems such as karaoke apparatus are often used for song selection. However, the process of song selection in the multimedia systems is often complex and confusing and different multimedia systems provide different song selection methods, such as title search, word count search, and searching by artist name. When selecting a desired song by title search, a user must be able to recall the song title in advance. If the user cannot recall any part of the song title, it would be difficult to find the song. Additionally, most multimedia systems further include a remote control device with input keys. However, a user needs to press keys repeatedly on the remote control device to select the desired songs. Furthermore, inputting a first word of a song title is also problematic because many song titles may begin with the same first word. Therefore, searching a desired song by title in the multimedia system is a very complex procedure.

When selecting a desired song through word count search, a user also must recall a song title in advance or get the word count of the song, and the multimedia system stores a plurality of songs which have the same word count. When selecting songs by artist name, first a user searches for the artist name; second the user makes a selection from the songs displayed under the artist name. Thus, the user would need to scroll through an entire listing of available songs, in order to find the desired song. These methods all require that a user must know the exact song titles or artist(s) name in advance and spend a significant amount of time to search for a desired song in the multimedia systems.

Accordingly, it would be beneficial to provide a portable electronic device with a song selection function that could overcome the above-mentioned disadvantages in traditional song selection methods.

### SUMMARY OF THE INVENTION

A portable electronic device with a song selection function is provided, the portable electronic device includes a storage unit for storing multimedia files; an input unit for generating input instructions; a display unit for displaying information; a list displaying module, for acquiring the multimedia files from the storage unit, and displaying an acquired song choosing interface on the display unit; a song selecting module connecting with the list displaying module, for selecting desired songs from the acquired song choosing interface; and a wireless communication unit, connected to a multimedia system, for encoding the desired songs and signaling the multimedia system to invoke remote multimedia files.

A method performing a song selection function in a portable electronic device is provided, the method includes the steps of: (a) storing multimedia files in the portable electronic device; (b) selecting a desired song from the multimedia files; and (c) encoding the desired song and sending an encoded signal to a multimedia system.

Other advantages and novel features will be drawn from the following detailed description with reference to the attached drawings.

### BRIEF DESCRIPTION OF THE DRAWINGS

FIG. 1 is a block diagram of a portable electronic device with a song selection function in accordance with a preferred embodiment of the present invention;

FIG. 2 is a block diagram of a processing unit of the portable electronic device of FIG. 1;

FIG. 3 shows an exemplary user interface of the portable electronic device of FIG. 1;

FIG. 4 shows an exemplary user interface of search files methods of the portable electronic device of FIG. 1.

FIG. 5 shows an exemplary song choosing interface for browsing files on the portable electronic device of FIG. 1;

FIG. 6 shows an exemplary song choosing interface for search in local play history on the portable electronic device of FIG. 1;

FIG. 7 shows an exemplary song choosing interface for search in remote play history on the portable electronic device of FIG. 1; and

FIG. 8 is a flowchart illustrating a preferred method of performing a song selection function in the portable electronic device of FIG. 1.

### DETAILED DESCRIPTION OF THE INVENTION

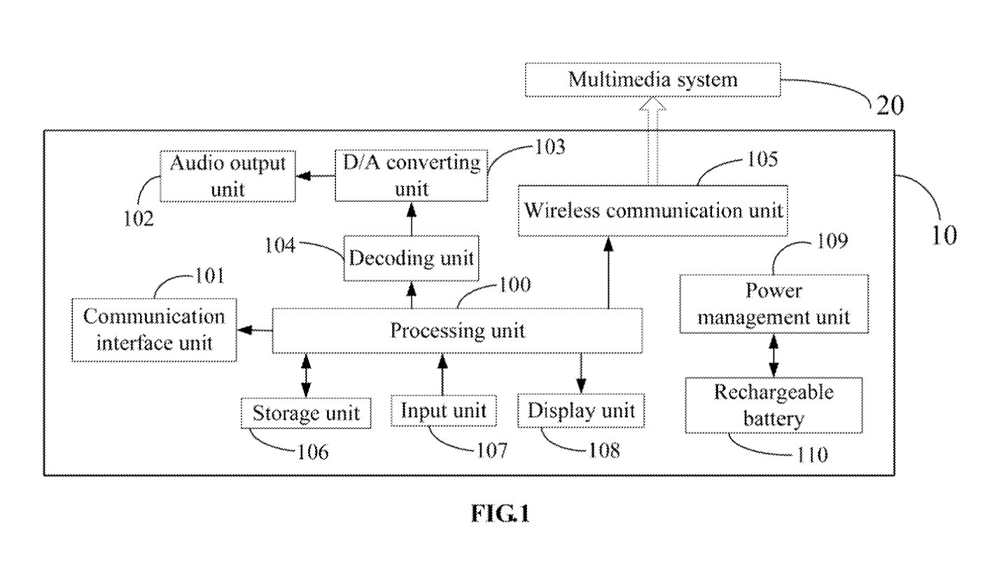

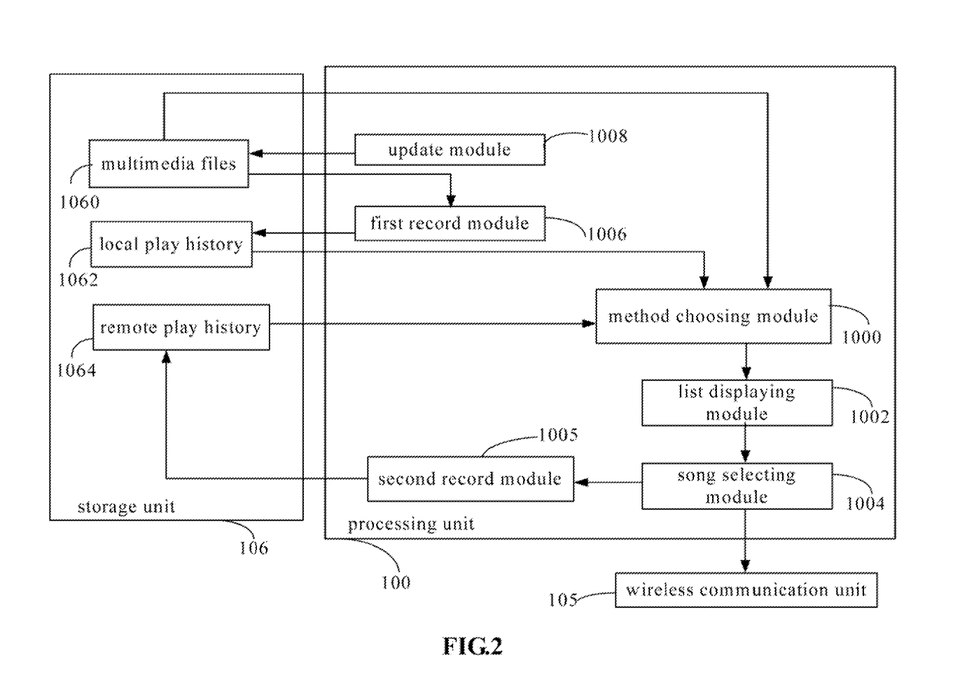

FIG. 1 shows one embodiment of a block diagram of a portable electronic device (hereinafter, “the device”) with a song selection function. The device 10 includes a processing unit 100, an audio output unit 102, a D/A converting unit 103, a decoding unit 104, a wireless communication unit 105, a storage unit 106, a communication interface unit 101, an input unit 107, a display unit 108, a power management unit 109, and a rechargeable battery 110. The power management unit 109 is configured for connecting to the rechargeable battery 110. The rechargeable battery 110 is configured for supplying power to all units of the device 10. The communication interface unit 101 is configured for connecting with a data processing system such as a personal computer (PC) (not shown). When establishing a connection with the PC, the device 10 receives data (e.g., multimedia files) from the PC, and stores the data in the storage unit 106. The storage unit 106 is configured for storing multimedia files 1060, a local play history 1062, and a remote play history 1064 (see FIG. 2). The input unit 107 is configured for generated input instructions to the processing unit 100. The processing unit 100 is configured for controlling operations and performing functions of the device 10 according to input instructions generated by the input unit 107. The display unit 108 is configured for displaying information.

The decoding unit 104 is configured for decoding multimedia data and transmits decoded digital signals to the D/A converting unit 103. The D/A converting unit 103 is configured for converting the digital signals, thereby yielding analog signals and transmits the analog signals to the audio output unit 102, thus reproducing the multimedia files. The audio output unit 102 may be an earphone or a speaker (not shown). The wireless communication unit 105, connected to a multimedia system 20, is configured for encoding desired multimedia files and signaling the multimedia system 20 to invoke remote multimedia files. The multimedia system 20 stores mass multimedia files and plays the multimedia files. The wireless communication unit 105 may be a Bluetooth module, a Wi-Fi communication unit, or a Wi-Max (broadband wireless access) communication unit. Correspondingly, the multimedia system 20 has a corresponding wireless receiving unit for communicating with the wireless communication unit 105 of the device 10.

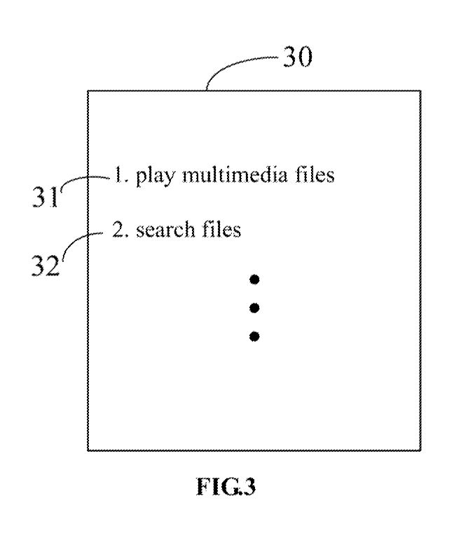

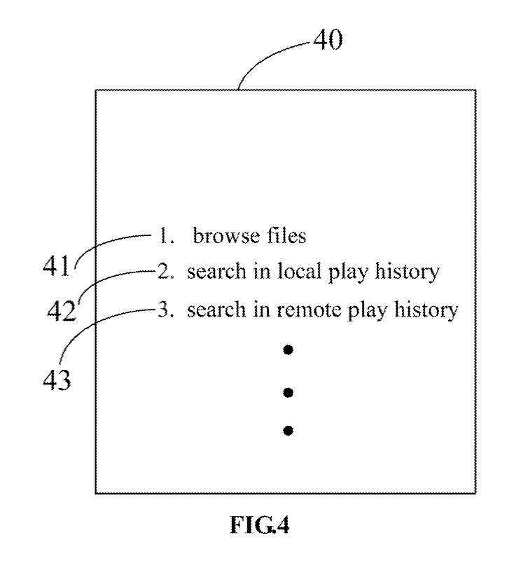

FIG. 2 is a block diagram of the processing unit 100 of the device 10 FIG. 1. The processing unit 100 includes a method choosing module 1000, a list displaying module 1002, a song selecting module 1004, an update module 1008, a first record module 1006, and a second record module 1005. The method choosing module 1000 is configured for selecting a search file method (see FIG. 4) corresponding to search files 32 (see FIG. 3). The list displaying module 1002 is configured for reading a song choosing interface according to the search file method, and displaying the song choosing interface on the display unit 108. The song selecting module 1004, connecting with the list displaying module 1002, is configured for selecting desired songs from the song choosing interface and sending data/information of the desired songs to the wireless communication unit 105, according to input instructions generated from the input unit 107. The second record module 1005, connecting with the song selecting module 1004, is configured for updating the remote play history 1064 in the storage unit 106. After the device 10 plays a multimedia file, the first record module 1006 updates the local play history 1062 in the storage unit 106. After the device 10 establishes communication with a PC or other external storage device, the updating module 1008 obtains multimedia files from the PC or any other external storage device, thereby updating the multimedia files 1060 in the storage unit 106.

The device 10 has a plurality of operation options. In each of the operation options, the device 10 can perform a particular function. In the embodiment in FIG. 3, a first user interface 30 of the device 10 illustrates two options, i.e., a play multimedia files option 31 and a search files option 32. The play multimedia files option 31 is a play on local device (the device 10) option and the search files is a play on remote device (the multimedia system 20) option. The device 10 and the multimedia system 20 all can play multimedia files. The options are selectable through the input unit 107 to control the device 10 to be in the play multimedia files 31 or the search files 32.

When the processing unit 100 receives a play instruction from the input unit 107 corresponding to the play multimedia files 31, the device 10 reads a play list consisting of a subset of the multimedia files 1060. Then the processing unit 100 sends multimedia data of the multimedia files corresponding the play list to the decoding unit 104. The decoding unit 104 decodes the multimedia data and transmits digital signals to the D/A converting unit 103. The D/A converting unit 103 converts the digital signals, thereby yielding analog signals and transmits the analog signals to the audio output unit 102, thus reproducing the multimedia files.

When the search files option 32 such as that shown in FIG. 3 is selected with the input unit 107, the device 10 performs a search files function. Then the processing unit 100 controls the display unit 108 to display a second user interface 40, which is a submenu of the search files option 32 such as that shown in FIG. 3. The second user interface 40, namely a song selection method user interface 40, includes a browse files option 41, a search in local play history option 42, and search in remote play history option 43. When one of the song selection methods is selected according to the instructions from the input unit 107, the processing unit 100 controls the device 10 to perform a file search function, and controls the display unit 108 to display a file search graphical user interface (GUI). The processing unit 100 is also configured for controlling the wireless communication unit 105 to signal the multimedia system 20 to invoke multimedia files of the multimedia system 20 in the storage unit 105 according to files selected.

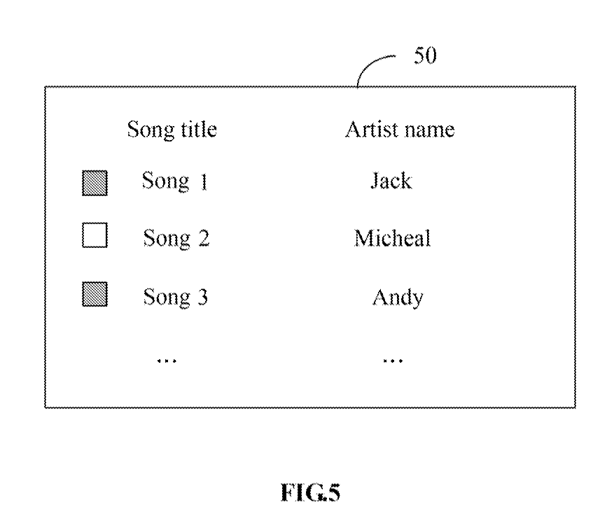

When the processing unit 100 receives an input instruction corresponding to the browse files option 41, the method choosing module 1000 chooses the browse files option 41, and the list displaying module 1002 acquires the multimedia files 1060 in the storage unit 106 directly and generates a third song choosing interface 50 (see FIG. 5) on the display unit 108. The third song choosing interface 50 includes bibliographic information of the multimedia files, such as song titles, artist(s) name. After the display unit 108 shows the third song choosing interface 50, the song selecting module 1004 receives selecting input instructions generated from the input unit 107 and obtains desired songs. Meanwhile, the device 10 is searched for desired songs on the third song choosing interface 50, by the first word of song title, the first word of artist name, and the like. And then the song selecting module 1004 sends the desired songs to the wireless communication unit 105. The wireless communication unit 105 encodes the desired songs and signals the multimedia system 20 to invoke remote multimedia files. In other cases, the song selecting module 1004 transmits one song to the wireless communication unit 105 one time and the wireless communication unit 105 encodes the song and sends the wireless signal to invoke the song in the multimedia system 20.

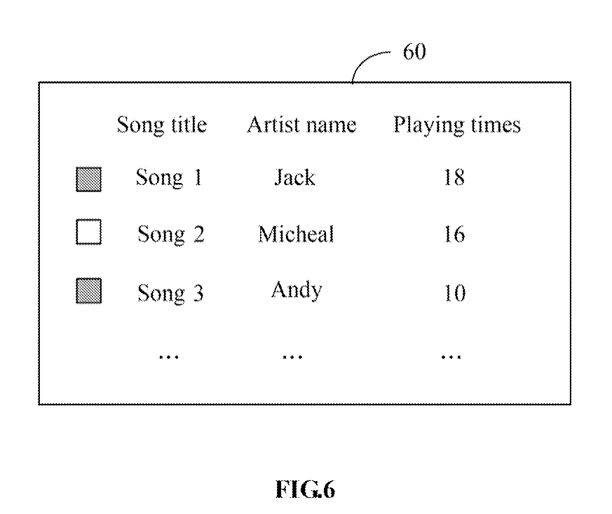

When the choose module 1000 chooses the search in local play history option 42, the list displaying module 1002 gains the local play history 1062 in the storage unit 106. The display unit 108 shows a fourth song choosing interface 60 such as that shown in FIG. 6. The fourth song choosing interface 60 includes bibliographic information of the multimedia files, such as song titles, artist(s) name and playing times. After the device 10 plays a multimedia file, the first record module 1006 updates the local play history 1062, thereby adding the playing times of the multimedia file. The fourth song choosing interface 60 displays multimedia data/information in a descending order according to playing times of the songs, such as that shown in FIG. 6. In search in local play history 42, the methods of selecting songs are the same as browse files 41, so the corresponding description is omitted herein.

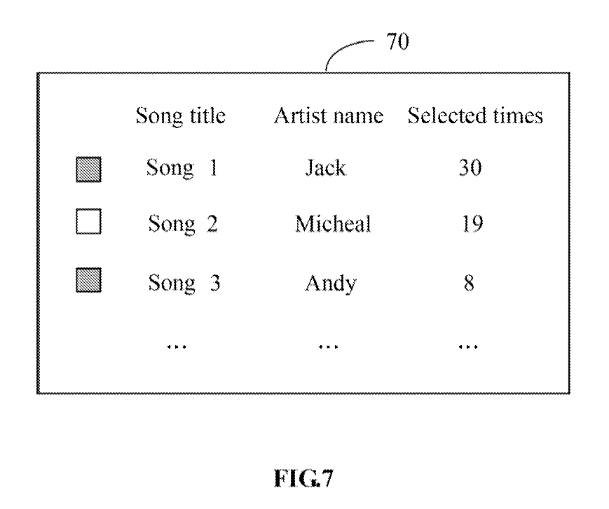

When the method choosing module 1000 chooses search in remote play history 43, the list displaying module 1002 gains the remote play history 1064 in the storage unit 106. The display unit 108 shows a fifth song choosing interface 70 such as that shown in FIG. 7. The fifth song choosing interface 70 includes bibliographic information of the multimedia files, such as song titles, artist(s) name and selected times. The second record module 1005, connecting with the song selecting module 1004, is configured for updating the remote play history 1064. Once the song selecting module 1004 sends a desired song to the wireless communication unit 105 by a song selection method from browse files 41, search in local play history 42 and search in remote play history 43, the second record module 1005 updates the remote play history 1064, thereby adding the selected times of the multimedia file. The fifth song choosing interface 70 displays multimedia data/information in a descending order according to selected times of the songs such as that shown in FIG. 7. In search in remote play history 33, the methods of selecting songs are the same as browse files 41, so the corresponding description is omitted herein.

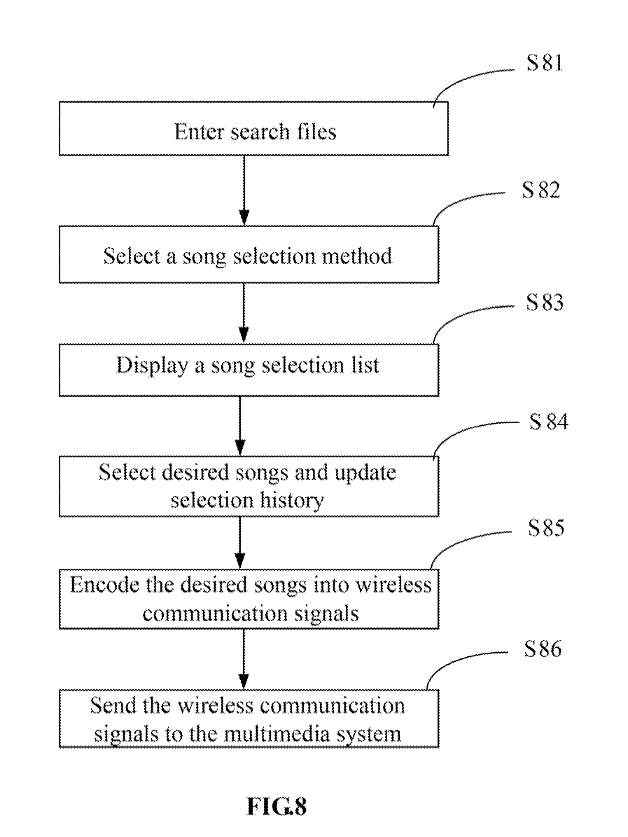

FIG. 8 is a flowchart illustrating a preferred method of performing a song selection function in the portable electronic device of FIG. 1. The device 10 provides a play multimedia files option 31 and a search files option 32 (see FIG. 3). And the search files option 32 provides several song selection methods, such as browse files 41, search in local play history 42, and search in remote play history 43 (see FIG. 4). In step S81, the portable electronic device 10 chooses the search files option 32 when the processing unit 100 receives a song selection instruction from the input unit 107 such as that shown in FIG. 3. In step S82, the processing unit 100 selects a song selection method from one of browse files 41, search in local play history 42 and search in remote play history 43, according to the input instruction generated from the input unit 107. In step S83, the list displaying module 1002 displays a song choosing interface from the song selection methods for a user to choose. In step S84, the song selecting module 1004 selects desired songs, and sends the desired songs to the wireless communication unit 105, and the second record module 1005 updates the remote play history 1064 in the storage unit 106. In step S85, the wireless communication unit 105 encodes the desired songs into wireless communication signals. In step S86, the wireless communication unit 105 sends the wireless communication signals to invoke the desired songs in the multimedia system 20.

Although the present invention has been explained in relation to its preferred embodiments including a preferred method, it is to be understood that many other possible modifications and variations can be made without departing from the spirit and scope of the invention as hereinafter claimed.

What is claimed is:

1. A portable electronic device with a song selection function, comprising:
a storage unit for storing multimedia files;
an input unit for generating input instructions;
a display unit for displaying information;
a list displaying module, for acquiring the multimedia files from the storage unit, and displaying an acquired song choosing interface on the display unit;
a song selecting module connecting with the list displaying module, for selecting desired songs from the acquired song choosing interface; and
a wireless communication unit, connected to a multimedia system, for encoding the desired songs and signaling the multimedia system to invoke remote multimedia files.

2. The portable electronic device as recited in claim 1, wherein when the list displaying module receives a song selection instruction from the input unit, the displaying unit displays a GUI providing a song selection method.

3. The portable electronic device as recited in claim 2, wherein the song selection methods comprise browse files, search in local play history, and search in remote play history.

4. The portable electronic device as recited in claim 1, wherein the storage unit further stores a local play history and a remote play history.

5. The portable electronic device as recited in claim 1, wherein the multimedia files comprise song titles and artist(s) name.

6. The portable electronic device as recited in claim 4, wherein the local play history comprise song titles, artist(s) name, and playing times.

7. The portable electronic device as recited in claim 4, wherein the remote play history comprise song titles, artist(s) name, and selected times.

8. The portable electronic device as recited in claim 1, further comprising an update module, for updating the multimedia files after the portable electronic device communicates with an external storage device.

9. The portable electronic device as recited in claim 1, further comprising a first record module, for updating the local play history after the portable electronic device plays a multimedia file in the storage unit.

10. The portable electronic device as recited in claim 1, further comprising a second record module, for updating the remote play history after the song selecting module selects a desired song.

11. The portable electronic device as recited in claim 1, wherein the wireless communication unit is a Bluetooth module.

12. A method of performing a song selection function in a portable electronic device, comprising:
storing multimedia files in the portable electronic device;
selecting a desired song from the multimedia files; and
encoding the desired song and sending an encoded signal to a multimedia system.

13. The method as recited in claim 12, further comprising:
storing a local play history and a remote play history.

14. The method as recited in claim 13, wherein the song selection method comprises three options, such as browse files, search in local play history, and search in remote play history.

15. The method as recited in claim 12, further comprising:
updating the multimedia files after the portable electronic device communicates with the external storage device.

16. The method as recited in claim 13, further comprising:
updating the local play history after the portable electronic device plays a multimedia file.

17. The method as recited in claim 13, further comprising:
updating the remote play history after the portable electronic device selects a desired multimedia file.
